(19) United States
(12) Patent Application Publication
(10) Pub. No.: US 2006/0057969 A1
(43) Pub. Date: Mar. 16, 2006

(54) Delay diversity in a wireless communication system

(76) Inventor: Wim Van Houtum, Sint-Oedenrode (NL)

Correspondence Address: PHILIPS INTELLECTUAL PROPERTY & STANDARDS, P.O. BOX 3001, BRIARCLIFF MANOR, NY, 10510, US

(21) Appl. No.: 10/537,068

(22) PCT Filed: Nov. 10, 2003
(86) PCT No.: PCT/IB03/05056

§ 371 Date: Jun. 1, 2005

Related U.S. Application Data
(60) Provisional application No. 60/431,124, filed on Dec. 4, 2002.

(51) Int. Cl. H04B 17/00; H04B 7/00

(52) U.S. Cl. 455/69; 455/67.13

(57) ABSTRACT

A wireless communication system for voice or data such as a WLAN system utilizes multiple transmit antennae and multiple receive antennae. The multiple transmit antennae exhibit different delay paths and the multiple receive antennae exhibit different delay paths. The delay of one of the transmit antennae paths is different from a delay of one of the receive antennae paths. In a preferred embodiment one of the transmit antenna paths uses a non-zero value delay component of a value which differs from the value of a non-zero value delay component of one of the receive antenna paths.

This invention relates to wireless communication systems and, more particularly, to wireless communication systems which employ delay diversity.

Wireless communication systems are in widespread use today for data and voice communication. One advantageous application of wireless communications is wireless local area networks (WLANs) for data and computer systems. WLANs do not require the installation of a hard-wired network and thus can be set up and brought to an operational state in a short amount of time and without the cost of a hard-wired infrastructure. Modern WLAN systems operating in accordance with IEEE Standard 802.11a which operate in the 5 GHz band are currently capable of bitrates up to 54 Mbit/sec., affording high speed data access for a significant number of users. Moreover, once the WLAN is operational, users enjoy significant mobility. The users are able to move around freely within the range of the access point or base station while maintaining communication with networks and other sources of information and communication. This means that users can relocate within the range of the access point without the need for rewiring or connection to a different data port, the common experiences when changing location on a hard-wired system.

Wireless networks however encounter a variety of interference and signal degradation problems from known sources. One common source of interference is the loss of signal due to Rayleigh fading. Raleigh fading arises due to multipath interference as reflected or retransmitted radio frequency (RF) signals destructively interfere with each other, causing RF signal cancellation and loss of signal. Multipath interference can arise from many commonly found sources such as walls, buildings, and other reflectors. Furthermore, the likelihood of Raleigh fading or multipath distortion increases with increases in the size of the wireless network and the distances between the access point and the mobile terminals using the system.

Various redundant transmission techniques and coding schemes have been proposed and implemented to deal with the problem of Rayleigh fading. One such scheme is described in international patent application WO01/78255, which describes receiver diversity from a base station equipped with a repeater to a final receiver. The IF signal is delayed and the original and the delayed signal are combined and transmitted by an antenna to the final receiver. At the receiver an antenna receives the combined signal and removes the delay spread by adaptive delay equalization processing so that the combined signals can be separated and demodulated as one signal. This patent discusses a (1,L) IF-receiver delay diversity single carrier system with the particular case that L=2. The theory behind such a system is that the artificially introduced multipath signal can be recognized and successfully decoded with minimal data loss with the help of an equalizer in the receiver.

While such an approach may provide acceptable performance for a voice communication system, data systems such as WLANs place much greater emphasis on the ability to accurately receive the signal data. In particular, improvements in signal-to-noise (SNR) of 2-3 dB can provide significant improvement in the bit error rates of data systems. Techniques which perform with low bit error rates in the presence of common Rayleigh fading are highly desirable.

In accordance with the principles of the present invention, a wireless communication system is provided which exhibits delay diversity at both the transmitter and the receiver. WLAN systems in which the mobile terminal and the access point both exhibit L antennas are known as (L,L) diversity systems. An (L,L) delay diversity system in accordance with the present invention does not rely solely upon the spatial diversity of the L antennas, but uses different delays in the antenna signal paths at both the transmitter and the receiver. In accordance with a further aspect of the present invention, a non-zero delay at one terminal (transmitter or receiver) is different from that of the other terminal, thereby providing a 2L diversity plus 10 log 10(L) dB improvement in performance.

In the drawings:

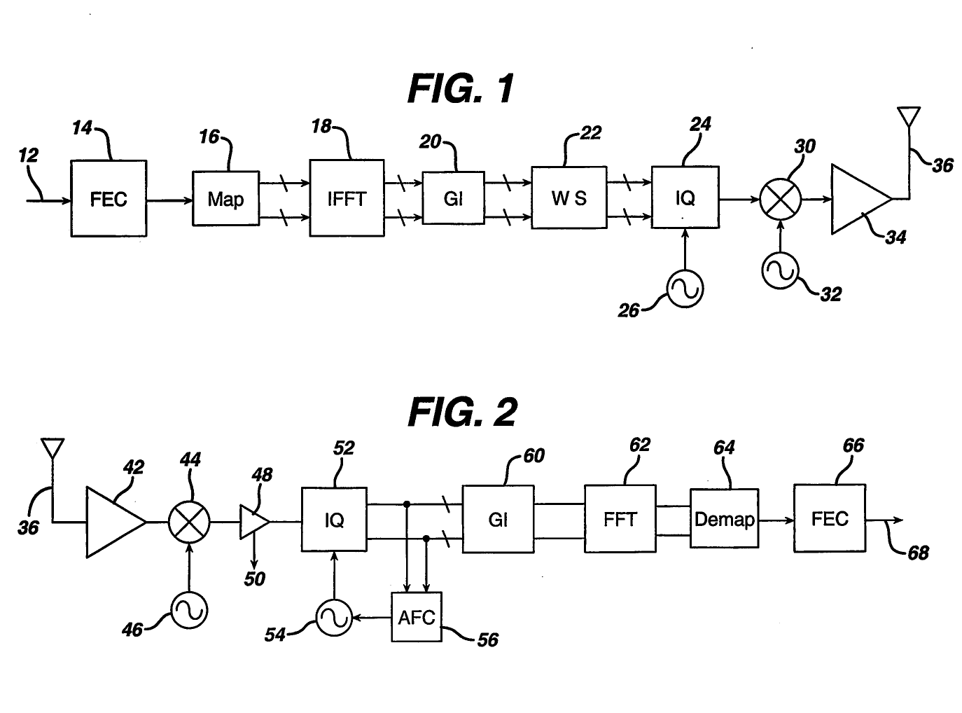

FIG. 1 illustrates in block diagram form the physical layer of an orthogonal frequency division multiplexing (OFDM) system transmitter,

FIG. 2 illustrates in block diagram form the physical layer of an OFDM system receiver; and

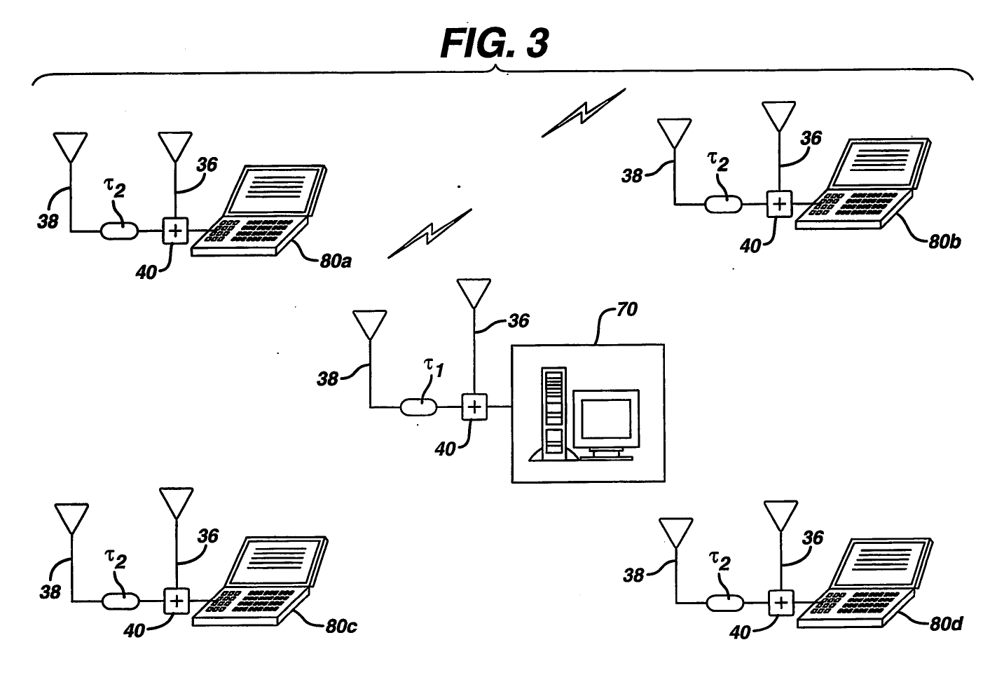

FIG. 3 illustrates a WLAN system using the OFDM transmitter and receiver of FIGS. 1 and 2 in an (L,L) RF delay diversity embodiment in accordance with the principles of the present invention.

Referring first to FIG. 1, the physical layer of an orthogonal frequency division multiplexing (OFDM) system transmitter is shown in block diagram form. The data to be transmitted is applied to the input 12 of the transmitter. The data may be packets of Internet Protocol (IP) data which is to be transmitted at a bit rate of 6, 9, 12, 18, 24, 36, 48, or 54 Mbits/sec. In the embodiment of FIG. 1 packets of 1518 bytes are to be transmitted at a maximum data rate of 54 Mbits/sec. The bytes comprise characters which are encoded, modulated and transmitted by the transmitter in a frame format. The embodiment of FIG. 1 uses a frame format which comprises a preamble of short and long training intervals which aid the receiver in acquisition. The preamble also includes a guard interval as discussed below. The preamble is followed by a header of one OFDM symbol, followed by a data field of a variable number of OFDM symbols.

The data is first encoded by a forward error correction coder 14, which codes the data by a coding scheme known and recognized by a decoder in the receiver. The identifiable coding scheme enables the receiver to correct data errors by recognizing incorrect codes and correcting them. The forward error correction coder of FIG. 1 employs convolutional coding with a coding rate R=½, ⅔, or ¾, corresponding to the desired data rate. For a data rate of 54 Mbits/sec, R=¾ was used. The encoded data bits are interleaved and mapped by a map processor 16. Interleaving resequences the bits to ensure that adjacent coded bits are mapped onto nonadjacent subcarriers and that less and more significant bits are alternately mapped so that long runs of bits of the same significance are avoided. This reduces errors due to the loss of continuous data sequences, as the encoded data is spread over the entire transmit burst. The data is now distributed in a complex plane for subsequent quadrature modulation and is mapped as 48 M-QAM symbols associated with 48 subcarriers for each OFDM symbol. In the embodiment of FIG. 1, 52 subcarriers are used, including four pilot subcarriers.

The complex numerical data now undergoes inverse fast Fourier transform processing 18. This transforms the subcarriers from the frequency domain to the time domain. The M-QAM symbols are now modulated at specific carrier frequencies in a time domain sequence. The system of FIG. 1 uses 52 subcarriers that are modulated using binary phase shift keying (BPSK), quadrature phase shift keying (QPSK), 16-quadrature amplitude modulation (16-QAM) or 64-QAM.

A guard interval 20 is added to provide redundancy that can be used to overcome fading problems. An OFDM symbol of period T is expanded to a lengthened period of T′. For example, the last sixteen samples of a group of sixty-four time samples can be copied and added to the group of sixty-four to produce 80 samples of an expanded period T′. This time dispersion of the samples prevents inter-symbol interference (ISI) problems during multipath reception.

The symbol data now undergoes waveshaping 22 to filter or shape the symbols and limit them to the desired bandwidth. The data is converted to analog signals and quadrature modulated at 24 to an intermediate frequency (IF) by intermediate frequency reference signals 26. The IF signals are then modulated to the 5.x GHz transmit frequency (RF frequency) by a carrier signal 32 applied to a mixer 30. The transmit waveform is amplified by a high power amplifier 34 and transmitted by an antenna 36.

FIG. 2 illustrates an OFDM receiver in which the coding and modulation performed by the transmitter is essentially reversed and the original data sequence recovered. The signals received by the antenna 36 are amplified by a low noise amplifier 42 and demodulated by a 5.x GHz reference signal 46 in a mixer 44. The demodulated signals are brought to a desired level by an automatic gain control amplifier 48, which detects the level of the received signal at an output 50. The signals are quadrature demodulated by an I-Q detector 52 by means of quadrature reference signals 54 which are stabilized by an automatic frequency control (AFC) feedback circuit 56. The quadrature demodulated signals are converted to digital signals and the guard interval is identified and removed by a guard interval removal processor 60. By recognizing and analyzing the guard interval, this processor will define the most appropriate sample to start the FFT-operation for eliminating ISI. The signals are converted from the time domain to the frequency domain by a fast Fourier transform processor 62. This produces discrete frequency bins with the M-QAM symbols. The M-QAM symbols are demapped and deinterleaved to the required bit sequence by a demap processor 64, which restores the original sequence of coded bits. The codes of the coded bits are recognized and analyzed by a forward error correction decoder 66, which attempts to correct dropout and other signal loss problems by recognizing erroneous codes and restoring correct codes. The decoded data at the output 68 comprises the original IP packet data. Further details of the transmission and reception processing of FIGS. 1 and 2 can be found in the 1999 supplement to IEEE Standard 802.11a.

A WLAN system using the OFDM transmitter and receiver of FIGS. 1 and 2 in accordance with the principles of the present invention is shown in FIG. 3. The illustrated system includes an access point terminal 70 for the WLAN, and four remote terminals 80a, 80b, 80c, and 80d, although it could have many more than four. Besides the transmit/receive antenna 36 shown in FIGS. 1 and 2, each terminal has a second antenna 38. The RF signals transmitted and received by the antennae 36 and 38 are separated and combined by an RF adder 40. Thus this system is an (LL) diversity system with L=2 for both transmit and receive, thereby comprising a (2,2) diversity system. In accordance with the principles of the present invention, the access point terminal 70 has its second antenna 38 coupled to the terminal by an RF delay τ₁, whereas each of the mobile terminals 80n has its second antenna 38 coupled to the terminal by a different RF delay shown as τ₂.

When a terminal is transmitting, the power P produced by the transmitter is applied to the antennae and is divided between the two antennae. Thus, each antenna is transmitting a power level of P/2, and both antennae together are transmitting a power level of P. There is therefore no signal to noise improvement from any increase in transmit power. Consequently, there is no increased demand on battery power in any of the mobile terminals, which is of significance for their time of operation between battery recharges. Importantly for the present invention, there is now a diversity of transmit signal paths, with one path exhibiting a delay of zero and the other a delay of τ₁.

At a receiving terminal, the signal power P radiated by the transmitting terminal is received by two antennae 36 and 38, each receiving the total power P radiated by both transmitting antennae. The multiple receiving antenna will therefore improve the signal to noise performance of the system since the total power received by both antennae is 2P. There is also a diversity of receive signal paths, as the RF signal path of the receiving antenna 38 of a mobile terminal exhibits a delay of τ₂ while the receiving antenna 36 exhibits a delay of zero.

This delay diversity at both the transmitter and receiver produces four signal paths between a transmitter and receiver which can be defined as follows:
H₁=0+0=0
H₂=τ₁+0=τ₁
H₃=0+τ2=τ₂
and
H₄=τ₁+τ₂
For example, if τ₁ is 100 nsec and τ₂ is 200 nsec, the four signal paths will have delays of zero, 100 nsec, 200 nsec, and 300 nsec.

The components used to provide the delays τ₁ and τ₂ in a constructed embodiment of the present invention do not have to be precision components; it is sufficient only that the delay values be sufficiently different so that the number of multiple delayed signal paths are produced. It will be appreciated that when a transmitting station becomes a receiving station and vice versa, the same result will hold because both antennae are again used at both the transmitting end and the receiving end.

The (L,L) delay diversity approach of the present invention is particularly useful with the transmitter and receiver shown in FIGS. 1 and 2 because they employ both guard interval protection and coding protection. The transfer function of each signal path or channel, which is the Fourier transform of the channel impulse response, will have spectral nulls due to these delays. These nulls will be at known and identifiable locations in the frequency domain due to the fixed values of the delays. The OFDM system exploits the fact that these delays in the time domain produce an identifiable frequency selective behavior in the frequency domain. These frequency nulls will attenuate a certain number of the M-QAM symbols, those that modulate the subcarriers within the vicinity of a spectral null. This attenuation can result in the loss of a certain number of bits and hence errors in the received bit sequence. However, many of these errors will be corrected by the forward error correction decoder 66, which will recognize the erroneous bit codes and correct them to valid codes. In addition, the guard interval 20 will help prevent the distortion of consecutive symbols by the reception of the delayed versions of the transmitted OFDM symbols. Consequently the system is virtually self-correcting for the inserted spectral nulls.

The (L,L) diversity system of the present invention reduces the effects of Rayleigh fading by the multiple receiving antennae which increase the received signal power, and by the reception of the multiple delayed versions of each transmitted signal. Spectral nulls due to the delays are overcome by coding-decoding of data and the use of a guard interval. The combining of delays at the transmitter and receiver produces an (L,L) diversity system with effective 2L diversity, and with an effective 10 log 10(1) dB increase in SNR performance. It will be obvious to those skilled in the art that additional antennas beyond two can be added to the transmitter, receiver, or both in a constructed embodiment of the present invention, with additional different delays to provide even greater performance improvement.

Other variations of the present invention will readily occur to those skilled in the art. For example, in a system where both the transmitter and the receiver use the same delay value τ₁, three distinct signal paths would be (in the case where one signal path has a delay of zero):
H₁=0+0=0
H₂=τ₁+0=τ₁
H₃=τ₁+τ₁=2τ₁
While not equaling the performance of the embodiment of FIG. 3 where τ₁ and τ₂ have different values, a significant performance improvement will still be realized by the diversity effect. While the embodiment of FIG. 3 shows the delays being used in the RF portion of the signal paths, it will be realized by those skilled in the art that the delays could also be IF delays used in separate IF signal paths of the two antennae, or could be baseband delays used in separate baseband signal paths of the two antennae.

What is claimed is:

1. A data communication system comprising:
a transmitter having first and second transmitting antennae (36, 38), the signal path of the first antenna (36) exhibiting a different delay than the signal path of the second antenna (38); and
a receiver having third and fourth receiving antennae (36, 38), the signal path of the third antenna (36) exhibiting a different delay than the signal path of the fourth antenna (38).

2. The data communication system of claim 1, wherein a nonzero delay of one of the signal paths of the first and second antennae (36, 38) is different from a nonzero delay of one of the signal paths of the third and fourth antennae (36, 38).

3. The data communication system of claim 2, wherein the value of one of the nonzero delays is twice the value of the other nonzero delay.

4. The data communication system of claim 1, wherein the transmitter further comprises a transceiver which is capable of both transmission and reception at different times by means of the first and second antennae (36, 38); and
wherein the receiver further comprises a transceiver which is capable of both transmission and reception at different times by means of the third and fourth antennae (36, 38).

5. The data communication system of claim 1, wherein the data further comprises voice data.

6. The data communication system of claim 1, wherein the data further comprises digital data.

7. The data communication system of claim 1, wherein the RF signal path of the first antenna (36) comprises an RF delay element and an RF adder (40) and the signal path of the second antenna (38) comprises an RF adder (40); and
wherein the RF signal path of the third antenna (36) comprises an RF delay element and an RF adder (40) and the RF signal path of the fourth antenna (38) comprises an RF adder (40).

8. The data communication system of claim 1, wherein the transmitter further comprises at least one or more of a coder (14) and a guard interval insertion processor (20); and
wherein the receiver further comprises at least one or more of a decoder (66) responsive to codes utilized by the coder (14) and a guard interval recognition processor (20).

9. The data communication system of claim 1, wherein the delays comprise RF delays.

10. The data communication system of claim 1, wherein the delays comprise IF delays.

11. The data communication system of claim 1, wherein the delays comprise baseband delays.

12. A WLAN system comprising:
an access point having a transceiver coupled to first and second transceiving antennae (36, 38), the signal path of the first antenna (36) exhibiting a different delay than the signal path of the second antenna (38); and
one or more mobile terminals (80a, 80b, 80c, 80d) each having a transceiver coupled to third and fourth (36, 38) transceiving antennae, the signal path of the third antenna (36) exhibiting a different delay than the signal path of the fourth antenna (38).

13. The WLAN system of claim 12, wherein a nonzero delay of one of the signal paths of the first and second antennae (36, 38) is different from a nonzero delay of one of the signal paths of the third and fourth antennae (36, 38).

14. The WLAN system of claim 13, wherein the value of one of the nonzero delays is twice the value of the other nonzero delay.

15. The WLAN system of claim 12, wherein the multiple antennae (36, 38) and different delays provide an (L,L) diversity system exhibiting 2L diversity plus 10 log 10(L) dB performance.

16. The WLAN system of claim 12, wherein each transceiver further comprises an OFDM system.

17. The WLAN system of claim 16, wherein the OFDM system utilizes one of binary phase shift keying (BPSK), quadrature phase shift keying (QPSK), 16-quadrature amplitude modulation (16-QAM) or 64-QAM.

18. The WLAN system of claim 12, wherein each transceiver further comprises at least one or more of a coder (14) and a guard interval insertion processor (20); and at least one or more of a decoder (66) responsive to codes utilized by the coder (14) and a guard interval recognition processor (20).

19. The WLAN system of claim 12, wherein the delays comprise RF delays.

20. The WLAN system of claim 12, wherein the delays comprise IF delays.

21. The WLAN system of claim 12, wherein the delays comprise baseband delays.
